(19) United States
(12) Patent Application Publication
(10) Pub. No.: US 2014/0149902 A1
(43) Pub. Date: May 29, 2014

(54) ELECTRONIC DEVICE WITH TOUCH SENSITIVE DISPLAY

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: ZHI-QIANG LIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/869,968

(22) Filed: Apr. 25, 2013

(30) Foreign Application Priority Data
Nov. 23, 2012 (CN) 2012104809355

(51) Int. Cl. G06F 3/0482

(52) U.S. Cl. CPC G06F 3/0482
USPC 715/765

(57) ABSTRACT

An electronic device includes a processor to execute an interface module to cause an interface to be displayed on a touch sensitive display. The interface includes a slide button, a path, and a character panel. The slide button is slidable along the path, and the character panel includes a number of characters. The processor is used to determine a position of the slide button where a sliding direction of the slide button changes from a first direction to a second direction opposite the first direction, and further used to determine one of the characters corresponding to the position and select the one of the characters.

### BACKGROUND

1. Technical Field

The present disclosure relates to electronic devices with a touch display, and particularly to a method for selecting a character implemented by the electronic device with a touch sensitive display.

2. Description of Related Art

Electronic devices such as cell phones and tablet computers usually include a touch sensitive display. The electronic devices can be locked and unlocked. For example, some of the electronic devices provide a screen locking interface allowing a user to slide a slide button to a preset position to unlock the screen. Although the screen interfaces of the electronic devices can satisfy basic requirements, an electronic device with a new screen unlocking interface is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram of an electronic device with touch sensitive display according to one embodiment.

FIG. 2 is a screen unlocking interface of the electronic device of FIG. 1 according to a first embodiment.

FIG. 3 is a screen unlocking interface of the electronic device of FIG. 1 according to a second embodiment.

FIG. 4 is similar to FIG. 3, but showing a slide button and a pointer in positions different from in FIG. 3.

FIG. 5 is a flowchart of a method for selecting a character according to one embodiment.

### DETAILED DESCRIPTION

Embodiments of the present disclosure will be described with reference to the accompanying drawings.

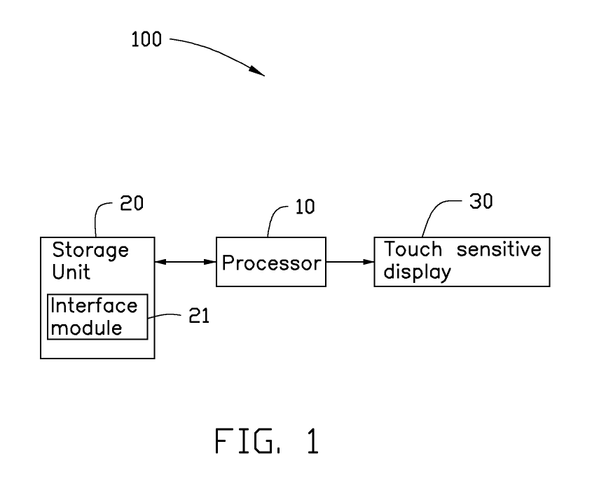

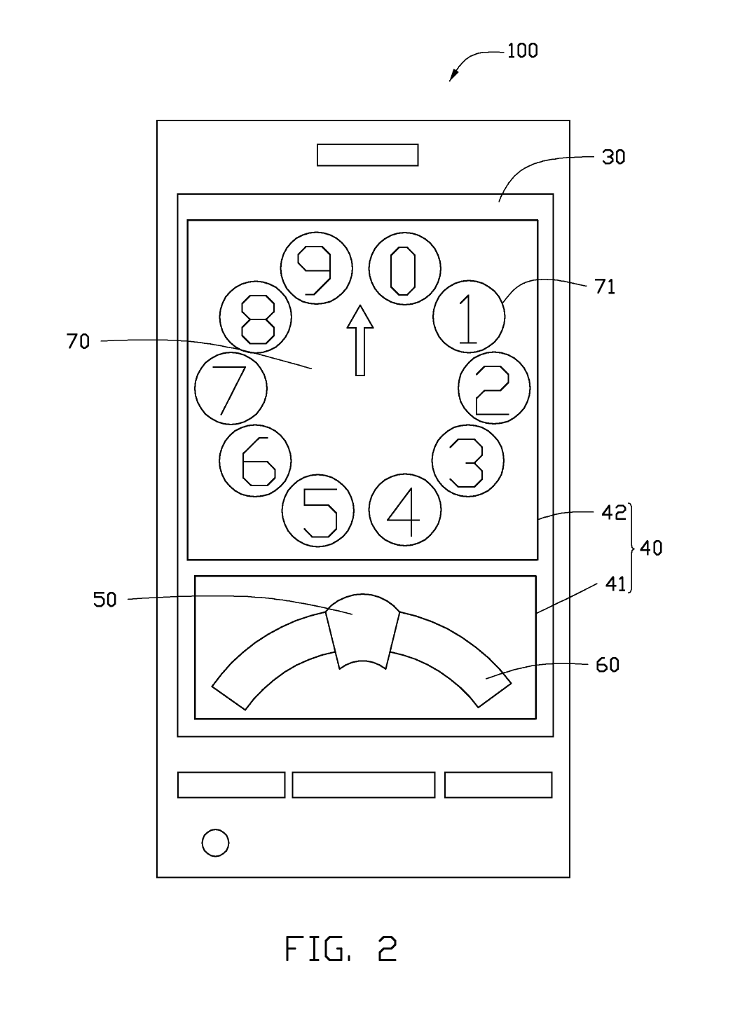

Referring to FIGS. 1 and 2, an electronic device 100 includes a processor 10, a storage unit 20, and a touch sensitive display 30. The storage unit 20 stores an interface module 21. The processor 10 can execute the interface module 21 and causes an interface 40 to be displayed on the display 30. The interface 40 includes a slide button 50, a path 60, and a character panel 70 including several characters 71. The slide button 50 can be dragged by a user to slide along the path 60.

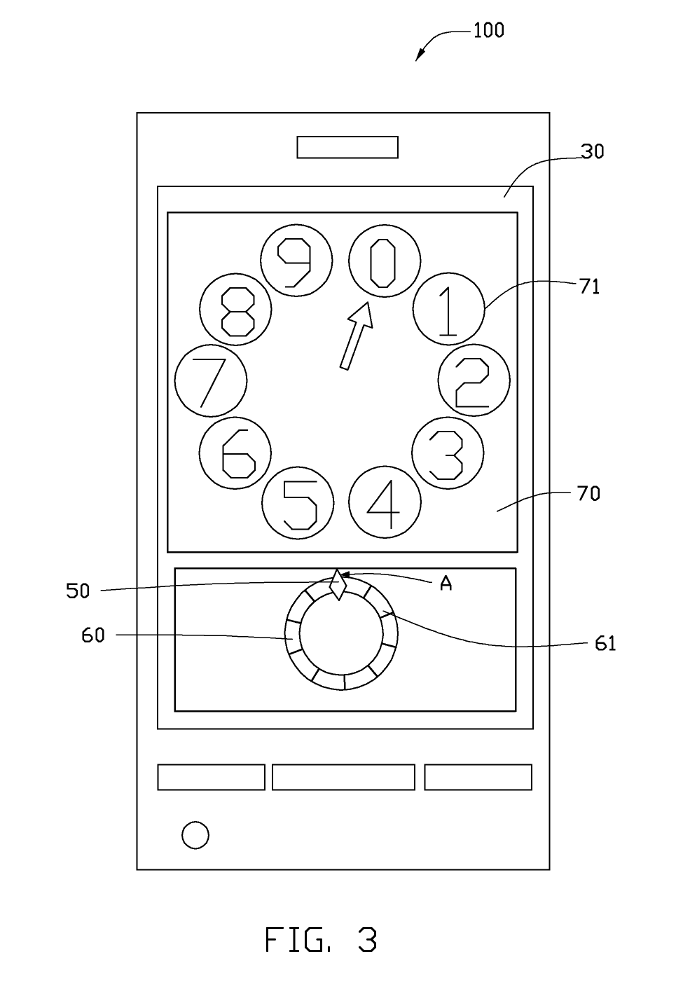

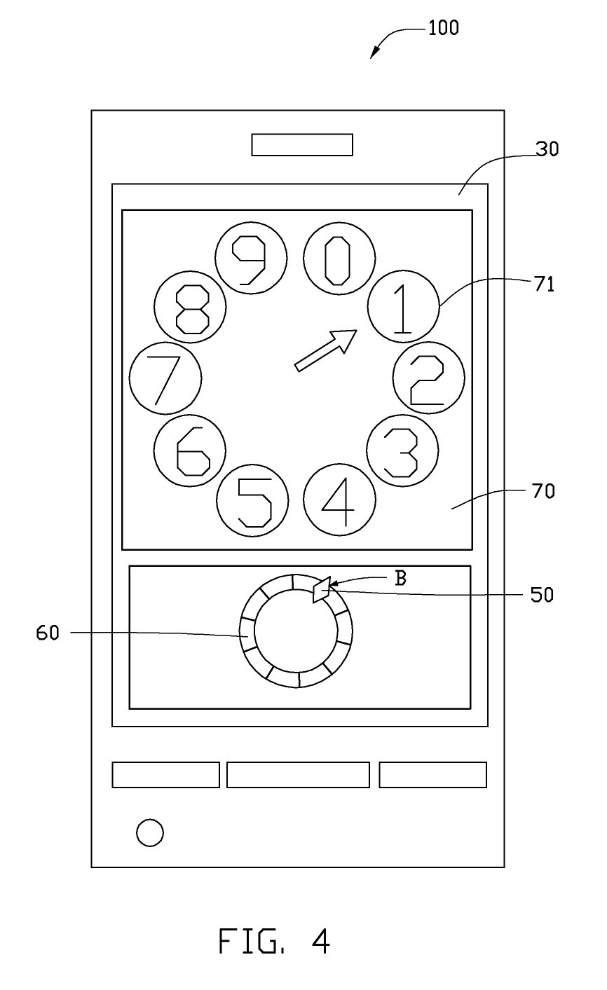

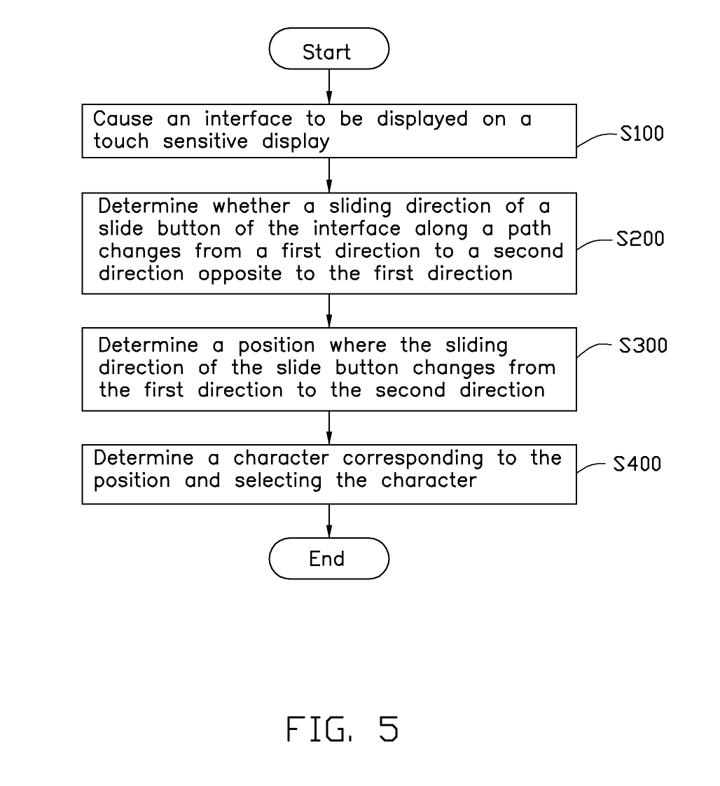

Referring to FIGS. 3 and 4, in one embodiment, the interface 40 includes a lower area 41 and an upper area 42. The slide button 50 and the path 60 are arranged within the area 41, and the character panel 70 is arranged within the area 42. The path 60 is circular or arcuate. Different position on the path 60 is associated with one of the characters 71 of the character panel 70. In the embodiment as shown in FIGS. 4 and 5, a number of marks 61 are set on the path 60 and are used to indicate different positions associated with different characters 71.

In the embodiment, the clockwise direction along path 60 of FIGS. 3 and 4 are defined as a first direction, and the counterclockwise direction along path 60 is defined as a second direction. The processor 10 can determine the position of the slide button 50 on the path 60 when the sliding direction of the slide button 50 changes between the first direction and the second direction. When the position of the slide button 50 on the path 60 is determined, the processor 10 further determines a character 71 associated with the determined position and selects the determined character 71. In the embodiment, the selected character 71 is highlighted.

In one embodiment, the interface 40 can be used as a screen locking interface, and a user is required to input a password to unlock the screen. Take FIGS. 3 and 4 for example, given that a user wants to input a password “01,” he/she needs to rotate the slide button 50 clockwise along the path 60 to a position A as shown in FIG. 3 and then rotates the slide button 50 counterclockwise, the processor 10 then determines that the character “0” is associated with the position A and selects character “0.” Similarly, to input character “1,” a user needs to rotate the slide button 50 clockwise along the path 60 to a position B as shown in FIG. 4 and then rotates the slide button 50 counterclockwise.

In the embodiment, the interface 40 further includes an indicator 72 associated with the slide button 50. When the slide button 50 rotates clockwise, the indicator 72 rotates clockwise; and when the slide button 50 rotates counterclockwise, the indicator 72 rotates counterclockwise. The indicator 72 points to a character associated with the current position of the slide button 50.

FIG. 5 shows a flowchart of a method for selecting a character implemented by the electronic device 100. In step S100, the processor 10 causes the interface 40 to be displayed on the display 30. In step S200, the processor 10 determines whether the sliding direction of the slide button 50 of the interface 40 along the path 60 changes from the first direction to the second direction. In step S300, the processor 10 determines the position where the sliding direction of the slide button 50 changes from the first direction to the second direction. In step S400, the processor 10 determines a character corresponding to the position and selects the determined character.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electronic device with touch sensitive display, the electronic device comprising:
a storage unit to store an interface module;
a touch sensitive display;
a processor configured to execute the module to cause an interface to be displayed on the touch sensitive display, the interface comprising a slide button, a path, and a character panel, the slide button being slidable along the path, the character panel comprising a plurality of characters, the processor being configured to determine a position of the slide button where a sliding direction of the slide button changes from a first direction to a second direction opposite the first direction, and further configured to determine one of the characters corresponding to the position and select the one of the characters.

2. The electronic device according to claim 1, wherein the one of the characters is highlighted.

3. The portable communication device according to claim 1, wherein the path is circular or arcuate.

4. The portable communication device according to claim 1, wherein the path is circular and comprises a plurality of marks, each of the marks corresponds to one of the plurality of characters.

5. A method for selecting a character, comprising:
causing an interface to be displayed on a touch sensitive display;
determining whether a sliding direction of a slide button of the interface along a path changes from a first direction to a second direction opposite to the first direction;
determining a position where the sliding direction of the slide button changes from the first direction to the second direction;
determining a character corresponding to the position and selecting the character.

6. The method according to claim 5, further comprising highlighting the determined character.
